(19) United States
(12) Patent Application Publication
(10) Pub. No.: US 2025/0148658 A1
(43) Pub. Date: May 8, 2025

(54) CONTENT GENERATION METHOD AND APPARATUS, ELECTRONIC DEVICE, AND STORAGE MEDIUM

(71) Applicant: DOUYIN VISION CO., LTD., Beijing (CN)

(72) Inventors: Lei WAN, Beijing (CN); Yihao LIU, Beijing (CN)

(21) Appl. No.: 18/922,845

(22) Filed: Oct. 22, 2024

(30) Foreign Application Priority Data
Nov. 2, 2023 (CN) 202311451959.2

(51) Int. Cl. G06T 11/00; G06F 40/30; G06V 20/40

(52) U.S. Cl. CPC G06T 11/00; G06F 40/30; G06V 20/41; G06V 20/46; G06T 2200/24

(57) ABSTRACT

The present disclosure provides a content generation method and apparatus, an electronic device, and a storage medium. The method includes: obtaining first text content and an image prompt, where the first text content is used to describe content information of an image to be generated, and the image prompt is used to describe a generation requirement of the image to be generated; performing semantic analysis on the first text content and the image prompt based on a generative model to obtain a description keyword of the image to be generated corresponding to the first text content; and generating a target image corresponding to the first text content based on the description keyword of the image to be generated.

### CROSS REFERENCE TO RELATED APPLICATIONS

This present application claims the benefit of priority to Chinese Application No. 202311451959.2, filed on Nov. 2, 2023, the entire contents of which are incorporated herein by reference.

### TECHNICAL FIELD

The present disclosure relates to the field of computer technologies, and in particular, to a content generation method and apparatus, an electronic device, and a storage medium.

### BACKGROUND

When different information content needs to be transmitted to a user, for example, a novel, a pure text form is usually used. In addition, the user's demand for content consumption forms is increasingly diversified.

### SUMMARY

Embodiments of the present disclosure provide at least a content generation method and apparatus, an electronic device, and a storage medium.

According to a first aspect, an embodiment of the present disclosure provides a content generation method, including:
obtaining first text content and an image prompt, wherein the first text content is used to describe content information of an image to be generated, and the image prompt is used to describe a generation requirement of the image to be generated;
performing semantic analysis on the first text content and the image prompt based on a generative model to obtain a description keyword of the image to be generated corresponding to the first text content; and
generating a target image corresponding to the first text content based on the description keyword of the image to be generated.

According to a second aspect, an embodiment of the present disclosure further provides a content generation apparatus, including:
an information obtaining module configured to obtain first text content and an image prompt, wherein the first text content is used to describe content information of an image to be generated, and the image prompt is used to describe a generation requirement of the image to be generated;
a keyword determining module configured to perform semantic analysis on the first text content and the image prompt based on a generative model to obtain a description keyword of the image to be generated corresponding to the first text content; and
an image generation module configured to generate a target image corresponding to the first text content based on the description keyword of the image to be generated.

According to a third aspect, in an optional implementation of the present disclosure, an electronic device is further provided, including a processor and a memory, where the memory stores machine-readable instructions executable by the processor, the processor is configured to execute the machine-readable instructions stored in the memory, and when the machine-readable instructions are executed by the processor, the processor executes the steps in the above first aspect or any one of the possible implementations of the first aspect.

According to a fourth aspect, in an optional implementation of the present disclosure, a computer-readable storage medium is further provided, where a computer program is stored on the computer-readable storage medium, and when the computer program is executed by a processor, the steps in the above first aspect or any one of the possible implementations of the first aspect are implemented.

In this embodiment of the present disclosure, first text content used to describe content information of an image to be generated and an image prompt used to describe a generation requirement of the image to be generated are first obtained. Then, semantic analysis is performed on the first text content and the image prompt based on a generative model, to obtain a description keyword of the image to be generated corresponding to the first text content, and a target image corresponding to the first text content is generated based thereon.

It should be understood that the foregoing general description and the following detailed description are exemplary and explanatory only, and are not intended to limit the technical solutions of the present disclosure.

To make the above objectives, features, and advantages of the present disclosure more comprehensible, the following preferred embodiments are described in detail below with reference to the accompanying drawings.

### BRIEF DESCRIPTION OF THE DRAWINGS

In order to more clearly describe the technical solutions in the embodiments of the present disclosure, the accompanying drawings used in the description of the embodiments will be briefly described below. The accompanying drawings herein are incorporated in and form a part of the specification, illustrate embodiments consistent with the present disclosure, and are used together with the description to explain the technical solutions of the present disclosure. It should be understood that the following accompanying drawings show only some embodiments of the present disclosure, and therefore should not be considered as a limitation on the scope. For those of ordinary skill in the art, other related accompanying drawings can be obtained based on these accompanying drawings without creative efforts.

FIG. 1 is a flowchart of a content generation method according to an embodiment of the present disclosure;

FIG. 2 is a schematic diagram of a principle of a content generation process according to an embodiment of the present disclosure;

FIG. 3 is a flowchart of a method for a generation process from a plurality of first text content to a target video according to an embodiment of the present disclosure;

FIG. 4 is a flowchart of a method for obtaining an image prompt according to an embodiment of the present disclosure;

FIG. 5 is a flowchart of another method for obtaining an image prompt according to an embodiment of the present disclosure;

FIG. 6 is a schematic diagram of a content generation apparatus according to an embodiment of the present disclosure; and

FIG. 7 is a schematic diagram of an electronic device according to an embodiment of the present disclosure.

### DETAILED DESCRIPTION OF EMBODIMENTS

It may be understood that before the technical solutions disclosed in the embodiments of the present disclosure are used, the user shall be informed of the type, the scope of use, the use scenario, and the like of the personal information involved in the present disclosure in an appropriate manner in accordance with relevant laws and regulations, and the user's authorization shall be obtained.

In order to make the objectives, technical solutions, and advantages of the embodiments of the present disclosure clearer, the technical solutions in the embodiments of the present disclosure will be described clearly and completely below with reference to the accompanying drawings in the embodiments of the present disclosure. Apparently, the described embodiments are merely some but not all of the embodiments of the present disclosure. Usually, components of the embodiments of the present disclosure described and shown herein may be arranged and designed in various different configurations. Therefore, the detailed description of the embodiments of the present disclosure below is not intended to limit the scope of protection claimed by the present disclosure, but is merely representative of selected embodiments of the present disclosure. Based on the embodiments of the present disclosure, all other embodiments obtained by those of ordinary skill in the art without creative efforts shall fall within the scope of protection of the present disclosure.

It is found through research that the actual users have increasingly diverse requirements for content consumption forms, while the pure text form is relatively monotonous and has relatively low attraction to the users, and may be unable to meet the content consumption requirements of the users. In order to ensure diversified promotion of information content and the like, information content in a pure text form may be generated as content materials in other forms, for example, image materials of a novel may be created to display a central idea, chapter content, and the like of the novel more intuitively. However, for information content in the pure text form, how to ensure accurate generation of the information content in another form to enrich and improve the communication effect of the information content is also an urgent problem to be solved.

Based on the foregoing research, the present disclosure provides a content generation method. First text content used to describe content information of an image to be generated and an image prompt used to describe a generation requirement of the image to be generated are first obtained. Then, semantic analysis is performed on the first text content and the image prompt based on a generative model, to obtain a description keyword of the image to be generated corresponding to the first text content, and a target image corresponding to the first text content is generated based thereon, to implement image visual expression of any text content, convey corresponding content information to a user more vividly and intuitively, ensure cross-language expression of the text content, improve the communicative force and attraction of the text content to the user, and enhance the communication effect of the text content. For the effect description of the content generation apparatus, the electronic device, and the computer-readable storage medium, refer to the description of the content generation method, which is not described herein again.

For the defects in the above solution, the results are obtained by the inventors through practice and careful research. Therefore, both the discovery process of the above problems and the solutions proposed by the present disclosure for the above problems in the following should be the contributions made by the inventors to the present disclosure during the process of the present disclosure.

It should be noted that similar reference numerals and letters denote similar items in the following drawings. Therefore, once an item is defined in one drawing, it is not further defined and explained in the subsequent drawings.

To facilitate understanding of the present embodiment, a content generation method disclosed in an embodiment of the present disclosure is first described in detail. An execution subject of the content generation method provided in this embodiment of the present disclosure is generally an electronic device with a specific computing capability. The electronic device includes, for example, a terminal device, a server or another processing device. The terminal device may be a user equipment (UE), a mobile device, a cellular phone, a cordless phone, a personal digital assistant (PDA), a handheld device, a computing device, a vehicle-mounted device, a wearable device, or the like. The personal digital assistant is a handheld electronic device that has some functions of an electronic computer, may be used to manage personal information, browse the Internet, send and receive emails, and the like, and is generally not provided with a keyboard and may also be referred to as a palmtop computer. In some possible implementations, the content generation method may be implemented by a processor calling computer-readable instructions stored in a memory.

The content generation method provided in this embodiment of the present disclosure is described below by using an example in which the execution subject is a server.

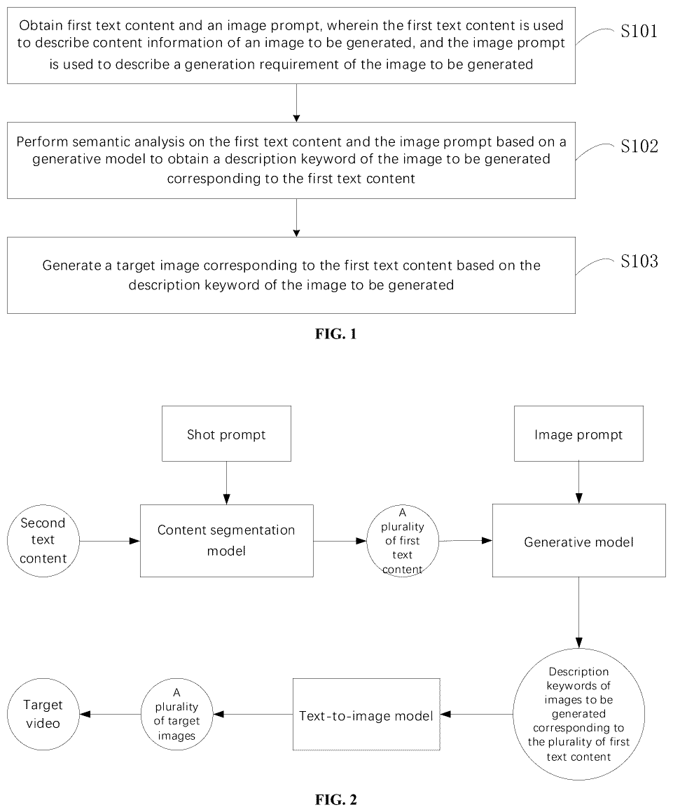

FIG. 1 is a flowchart of a content generation method according to an embodiment of the present disclosure. The method includes the following steps.

S101: Obtain first text content and an image prompt, wherein the first text content is used to describe content information of an image to be generated, and the image prompt is used to describe a generation requirement of the image to be generated.

In this embodiment of the present disclosure, a scenario in which a text is used to generate an image is mainly used to represent content in a pure text form as a high-quality image, thereby adding a visual expression effect to the text content and ensuring cross-language expression of the text content.

The first text content may be used to describe content information of one frame of image to be generated, and is described in a pure text form. For example, in this embodiment of the present disclosure, the first text content may be a corresponding text segment in any document, such as a novel, an article, or news, that can be used to describe content of a single image frame. The present disclosure does not limit a source of the first text content.

The first text content separately describes detailed frame content of the image to be generated from a plurality of perspectives and aspects, and different contexts of the first text content have different requirements for a style, a shooting angle of view, a subject, and the like of the image to be generated. Therefore, in this embodiment of the present disclosure, the generation requirement of the image to be generated corresponding to the first text content may be described by using the image prompt. The image prompt may include, but is not limited to, various image frame requirements such as a style, a tone, and a composition of the image to be generated, to describe frame details of the image to be generated in an all-round manner.

Therefore, in a text-to-image scenario, in order to implement image visual expression of any text content, the present disclosure first obtains the corresponding first text content and the image prompt corresponding to the first text content, so as to accurately generate a target image corresponding to the first text content subsequently.

In some implementations, for the first text content, the present disclosure may obtain the first text content through the following steps.

Step 1: Obtain second text content.

The second text content may be complete text content related to any document such as a novel, an article, or news. Some text segments are extracted from the second text content, to obtain the first text content.

It may be understood that if a document such as a novel, an article, or news is used as a target object, the second text content may be text recorded content of any target object, for example, specific text recorded content in a document such as a novel, an article, or news. Alternatively, the first text content may also be text summary content of any target object, for example, a summary, an abstract, a comment analysis, or the like of a document such as a novel, an article, or news.

Step 2: Segment the second text content by using a content segmentation model based on a shot prompt to obtain a plurality of first text content.

Because text description structures of the second text content are different, formats of text segments in the second text content used to describe content of a single image frame are also different. Therefore, the present disclosure may pre-train a content segmentation model, which is used to accurately segment a complete text into a plurality of text segments corresponding to single image frames based on a content segment description requirement for a single image frame.

In addition, because one first text content may describe content information of one image to be generated, and one image to be generated may be represented by one shot frame, the present disclosure may indicate a requirement for segmenting the second text content in a shot segment manner by using the shot prompt, for example, a text segmentation mark between shot segments.

In this embodiment of the present disclosure, after the second text content is obtained, a shot prompt corresponding to the second text content may be found. Then, as shown in FIG. 2, the second text content and the shot prompt are jointly input into the trained content segmentation model. Then, the shot prompt is analyzed by using the content segmentation model, to determine a corresponding shot segment manner, and the second text content is segmented into text segments corresponding to a plurality of single shots based on the shot segment manner, to obtain a plurality of first text content. Each second text content obtained after the second text content is segmented may correspond to one second text content segment.

S102: Perform semantic analysis on the first text content and the image prompt based on a generative model to obtain a description keyword of the image to be generated corresponding to the first text content.

It is considered that the first text content is usually an original text segment in a document such as a novel, an article, or news that is used to describe content of a single image frame. However, the document such as a novel, an article, or news belongs to text content described in a written language, and is not written with reference to a description manner of an image frame. Therefore, the first text content is difficult to be understood as an image description. When a corresponding image is generated based on frame analysis of the first text content alone, the attention of a text-to-image model to the first text content is limited, so that an ultimately generated image may be relatively simple, and frame details may not be that rich, which cannot ensure the quality and effect of text-to-image generation.

In this embodiment of the present disclosure, a generative model may be pre-trained, and is used to extract, from related text content, based on a generation requirement of an image to be generated, a description keyword required by the image to be generated. The description keyword can accurately and comprehensively describe the frame detail requirement of the image to be generated with reference to a description manner of an image frame.

For example, the generative model in the present disclosure may be a Chat Generative Pre-trained Transformer model (referred to as ChatGTP for short), and the ChatGTP model may be a chat language processing model based on a transformer architecture.

In this embodiment of the present disclosure, after the first text content and the image prompt are obtained, the first text content and the image prompt may be jointly input into the trained generative model. Then, corresponding semantic analysis is performed on the image prompt by using the generative model, to determine a specific generation requirement of the image to be generated, and semantic analysis is performed on the first text content under a particular requirement based on the specific generation requirement, to extract various key description information corresponding to the specific generation requirement from the first text content, to obtain a description keyword of the image to be generated corresponding to the first text content.

In some implementations, for the description keyword of the image to be generated corresponding to the first text content, the present disclosure may determine the description keyword through the following steps.

Step 1: Determine context information of each first text content based on a segmentation order of each first text content in the second text content.

It is considered that when the second text content is segmented by using the content segmentation model based on a shot segment manner described by the shot prompt, a plurality of first text content may be obtained, and the plurality of first text content belong to the same second text content, and therefore there is a corresponding context relationship.

Therefore, in this embodiment of the present disclosure, for the plurality of first text content obtained after the same second text content is segmented, the present disclosure may determine the segmentation order of each first text content in the second text content. Then, the individual first text content may be sorted based on the segmentation order of each first text content in the second text content.

For each of the plurality of first text content obtained after the same second text content is segmented, the present disclosure may perform semantic analysis on adjacent first text content of each first text content based on a sorting result of the first text content, to determine the context information of each first text content.

Step 2: Perform semantic analysis on the first text content, the context information of the first text content, and the image prompt based on a generative model for each first text content to obtain the description keyword of the image to be generated corresponding to the first text content.

The context information of each first text content also affects frame content of an image to be generated corresponding to the first text content. Therefore, for each first text content, the present disclosure jointly inputs the first text content, the context information of the first text content, and the image prompt into the trained generative model. Then, corresponding semantic analysis is performed on the image prompt by using the generative model, to determine a specific generation requirement of the image to be generated, and semantic analysis under a particular requirement is performed on the first text content and the context information of the first text content based on the specific generation requirement, to extract various key description information corresponding to the specific generation requirement from the first text content and the context information of the first text content, to obtain a description keyword of the image to be generated corresponding to the first text content, so as to ensure comprehensiveness and accuracy of the description keyword of the image to be generated.

S103: Generate a target image corresponding to the first text content based on the description keyword of the image to be generated.

After the description keyword of the image to be generated corresponding to the first text content is determined, specific frame detail information of the image to be generated may be determined through comprehensive analysis of the description keyword. Then, as shown in FIG. 2, the specific frame detail information of the image to be generated may be input into a corresponding text-to-image model, to generate a higher-quality target image for the first text content, thereby implementing image visual expression of any text content.

According to the technical solution provided in this embodiment of the present disclosure, first text content used to describe content information of an image to be generated and an image prompt used to describe a generation requirement of the image to be generated are first obtained. Then, semantic analysis is performed on the first text content and the image prompt based on a generative model, to obtain a description keyword of the image to be generated corresponding to the first text content, and a target image corresponding to the first text content is generated based thereon, to implement image visual expression of any text content, convey corresponding content information to a user more vividly and intuitively, ensure cross-language expression of the text content, improve the communicative force and attractiveness of the text content to the user, and enhance the communication effect of the text content.

As an optional implementation in this embodiment of the present disclosure, when the second text content is segmented by using the content segmentation model based on a shot segment manner described by the shot prompt, a plurality of first text content may be obtained.

In this embodiment of the present disclosure, for each of the plurality of first text content, a plurality of target images may be separately generated based on the description keyword corresponding to each first text content; and an order of the plurality of target images is determined based on the second text content and a preset rule, and a target video is generated based on the order, where the target video comprises at least part of the target images.

In other words, in the foregoing manner, a plurality of target images may be separately generated for the plurality of first text content based on the description keyword of the image to be generated corresponding to each first text content.

Then, a segmentation order of each first text content in the second text content may be determined based on a position of each first text content in the second text content. In addition, the present disclosure may indicate a content display order in a video through a preset rule, so that the target video can better adapt to a viewing habit of a user.

Therefore, the present disclosure may adjust the segmentation order of each first text content in the second text content based on the preset rule, to determine an order of the plurality of target images corresponding to each first text content. The target images are merged based on that order, as shown in FIG. 2, to generate a corresponding target video.

For example, the preset rule in the present disclosure may be to merge the target images based on description orders of the first text content, or may be to merge the target images based on an amount of climax information included in the individual first text content. This is not limited in the present disclosure.

In some implementations, for the target video, in this embodiment of the present disclosure, the target images corresponding to the plurality of first text content may be merged based on the segmentation order of each first text content in the second text content as the order of the target images, to generate a target video.

In other words, the present disclosure may use the segmentation order of each first text content in the second text content as the order of the target images, to determine a content playback order in the target video based on a description order of the individual first text content. Then, the target images corresponding to the plurality of first text content are merged based on the order thereof, to generate the target video.

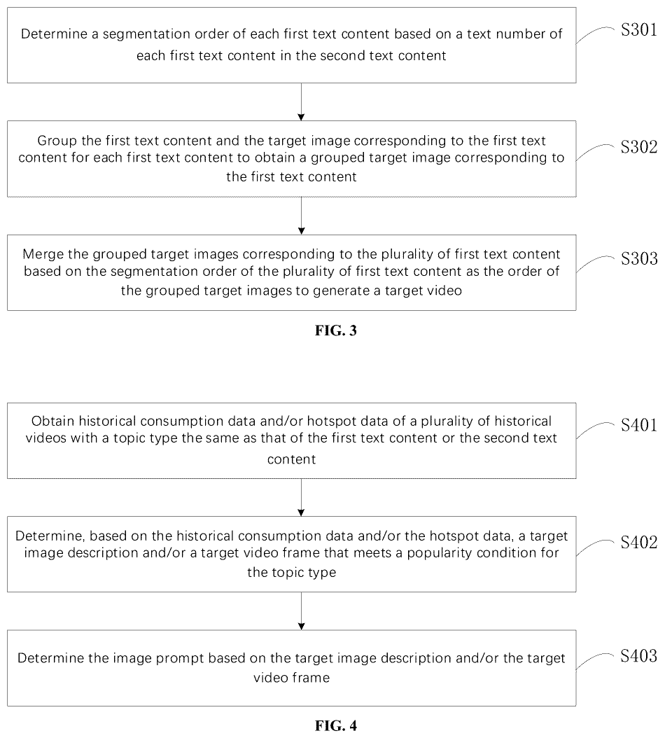

Specifically, as shown in FIG. 3, this embodiment of the present disclosure may generate the target video through the following steps.

S301: Determine the segmentation order of each first text content based on a text number of each first text content in the second text content.

In order to ensure quick sorting of the plurality of first text content, when the second text content is segmented by using the content segmentation model to obtain the plurality of first text content, the present application sequentially sets a text number for each first text content after the segmentation, to represent the segmentation order of each first text content. Therefore, the present disclosure can determine the segmentation order of each first text content by checking the text number of each first text content in the second text content.

S302: Group the first text content and the target image corresponding to the first text content for each first text content, to obtain a grouped target image corresponding to the first text content.

For each first text content, in order to ensure the browsability of the target video, the present disclosure may group each first text content and the target image corresponding to the first text content, and use the first text content as a subtitle of the target image, to improve the readability of the target image, to obtain a grouped target image corresponding to each first text content.

For example, for the grouped target image corresponding to each first text content, the first text content in the form of a subtitle may be displayed below the target image or at another position of the target image, which is not limited. For another example, the present disclosure may also transform a font, a color, or the like of each first text content, and then group the transformed first text content with the corresponding target image.

S303: Merge the grouped target images corresponding to the plurality of first text content based on the segmentation order of the plurality of first text content as the order of the grouped target images, to generate a target video.

For each grouped target image, the present disclosure may merge the grouped target images corresponding to the plurality of first text content based on the segmentation order of the plurality of first text content as the order of each grouped target image, to generate a target video, so that both a frame and a subtitle may be displayed in the target video.

In addition, in order to ensure efficient promotion of the target video, in this embodiment of the present disclosure, a target link may be added to the target video, and the target video is published on a target platform, to obtain consumption data of a user for the target link during playback of the target video, so as to update the image prompt for the topic type of the target video.

The target platform may be various video playback platforms, such as a short-video platform and an advertisement platform, to improve promotion traffic and awareness of the user for the corresponding text content involved in the target video.

In this embodiment of the present disclosure, the target link is added to the target video. The target link may be a website address link related to the first text content, a reading address link in a text application, and/or a related product link. Then, the target video to which the target link is added may be published on the target platform for playback. In addition, during playback of the target video, the user can view the corresponding target link and trigger the target link for consumption. Therefore, by detecting a trigger operation of the user for the target link in the target video, consumption behavior of the user for the target link can be obtained in real time, and the consumption behavior is analyzed and counted, to obtain corresponding consumption data.

The consumption data of the user for the target link may include, but is not limited to, a frame of target image played by the target video at a current moment when the user triggers the target link, and a specific generation requirement used for the target image.

Through analyzing the consumption data of the user for the target link, it may be initially determined that frame content, a style, and the like of the frame of target image played by the target video at the current moment when the user triggers the target link may be more attractive to the user, and frame elements, a style, and the like that are popular with the user may also be determined, so that the image prompt for the topic type of the target video may be continuously updated based on the consumption data. In this way, based on a more optimized image prompt, the generative model can generate higher-quality target image for each first text content and provide more accurate description keywords of an image to be generated, thereby improving the quality and effect of the target image of the first text content, better meeting the requirements of text-to-image generation, and improving the attraction to the user.

As an optional implementation in this embodiment of the present disclosure, the image prompt may include, but is not limited to, at least one of an image description dimension, a generation requirement for each image description dimension, and an image description reference sample. The image description reference sample may include reference text content and a description keyword of a reference image to be generated corresponding to the reference text content.

For example, the image description dimension may include, but is not limited to, an angle of view, a person in the scene, an image subject, a person emotion, a person action, an image background, and the like.

Taking the foregoing image description dimension as an example, the generation requirement for each image description dimension may be as follows:

1) Angle of view: It may be empty depending on a scene and a context selection, for example, a wide-angle, an aerial view, an overhead shot, and the like.

2) Person in the scene: If there is a person in the scene, a gender needs to be expressed, and a subject field is omitted; if there is no person in the scene, “person emotion” and “person action” do not need to be entered.

A person not mentioned in a shot cannot be automatically added to the scene; in addition to the person in the scene, a personal pronoun cannot be included, details may be described in a form of an adjective+a noun, and an action may be described in a form of a predicate+an object.

For a certain person mentioned in a dialogue, the person is described through description of the dialogue.

3) Image subject: Various forms of expressions of concrete images are used, for example, a young man/an old girl/a building/a farm, and the like.

4) Person emotion and person action: A specific emotion or action type is wrapped in parentheses, and a specific value is used to represent an intensity of the emotion or action, for example, (surprised: 1.2) or the like. Expressions of the emotion or action directly write out a facial image and body features, for example, cry, tear, closed eyes, and the like.

5) Image background: Plot coherence of a plurality of shots.

The image description reference sample may represent an example of a specific text content to a plurality of description keywords, and may include two parts: the reference text content and the description keyword of the reference image to be generated corresponding to the reference text content. The reference text content may be an example text of a complete first text content, and the description keyword of the reference image to be generated corresponding to the reference text content may be a specific description keyword of an image to be generated corresponding to the example text in each image description dimension. As shown in the following example:

“Reference text content: At first, no one cared about the disaster. Firstly, there was a high temperature that lasted for dozens of days, with a maximum temperature of even more than 45 degrees. Then, the fields were dry, and the lakes were cut off.

Description keyword of the reference image to be generated corresponding to the reference text content:
Angle of view: aerial view
Image subject: a drought disaster
Image background: high temperature, dry farms, empty lakes, dry lakes”.

In the embodiment of the present disclosure, in order to ensure accurate cross-language expression from the first text content to the target image, for the image prompt, as shown in FIG. 4, the present disclosure may obtain the image prompt through the following steps.

S401: Obtain historical consumption data and/or hotspot data of a plurality of historical videos with a topic type the same as that of the first text content or the second text content.

Because text content of different topic types has different popular image description manners of the generated target image in different topic types, the present disclosure may separately set a corresponding image prompt for each topic type.

In this embodiment of the present disclosure, for the first text content or the second text content from which a plurality of first text content can be segmented, a topic type of the first text content or the second text content may be first determined. Then, a plurality of historical videos of the same topic type that are published on the target platform are found based on the topic type of the first text content or the second text content, and historical consumption data of a user for a target link added to the plurality of historical videos is obtained and/or hotspot data of the user when watching the plurality of historical videos is obtained.

S402: Determine, based on the historical consumption data and/or the hotspot data, a target image description and/or a target video frame that meet a popularity condition for the topic type.

After the historical consumption data and/or the hotspot data of the plurality of historical videos with the topic type the same as that of the first text content or the second text content are obtained, corresponding analysis may be performed on the historical consumption data and/or the hotspot data of each historical video, and an image description manner and/or a related video frame with a large user consumption amount and/or a large user attention amount in each historical video are/is used as a generation requirement of an image popular with the user for the topic type. Therefore, the present disclosure may find, from each historical video for the topic type, the image description manner and the related video frame with the large user consumption amount and/or the large user attention amount, to obtain the target image description and/or the target video frame that meet the popularity condition for the topic type.

The target image description may include at least one of the following: an image style, a target shot angle of view, a target subject description, a target person description, a target emotion description, a target action description, and a target background description. The target video frame may be a corresponding video frame watched by the user when the consumption amount of the user is high in the historical video.

S403: Determine the image prompt based on the target image description and/or the target video frame.

After the target image description and/or the target video frame that meet the popularity for the topic type of the first text content or the second text content are obtained, corresponding analysis may be performed on a specific image description manner used for the target image description and/or the target video frame, to determine the corresponding image prompt.

In some implementations, by analyzing the specific description manner involved in each target image description, the image description dimension for the topic type and the generation requirement for each image description dimension may be determined.

Because the historical video may be obtained by merging historical target images generated from a plurality of historical text content, the target video frame is also generated by a text-to-image model based on a certain historical text content. Therefore, the present disclosure may find the historical text content used for each target video frame, and determine a description keyword of an image referred to when the historical text content generates the target video frame, to form a corresponding image description reference sample. The historical text content used for the target video frame may be the reference text content, and the description keyword of the image referred to when the historical text content generates the target video frame may be used as the description keyword of the reference image to be generated corresponding to the reference text content.

In one or more embodiments of the present disclosure, when the image prompt includes the image description reference sample, as shown in FIG. 5, the image prompt may also be obtained through the following steps.

S501: Determine a topic type of the first text content.

Because text content of different topic types has different popular image description manners of the generated target image in different topic types, the present disclosure first needs to determine the topic type of the first text content before obtaining the image prompt, to obtain a suitable image prompt for the topic type.

S502: Determine a corresponding image description reference sample based on a user input image description for the topic type.

For the topic type of the first text content, a user may manually input some example text content for the topic type and a corresponding description keyword of an image, to obtain the user input image description for the topic type. Then, a text example in the user input image description may be used as the reference text content in the image description reference sample, and each image description keyword output for the text example in the user input image description may be used as the description keyword of the reference image to be generated corresponding to the reference text content in the image description reference sample.

S503: Determine the corresponding image description reference sample based on the topic type by using a constructed reference sample library or a sample generation model.

To ensure the accuracy of the image description reference sample, the present disclosure may further pre-construct a reference sample library, where the reference sample library may include a plurality of image description reference samples set for each topic type.

Alternatively, the present disclosure may further pre-train a sample generation model, which is used to accurately generate a suitable image description reference sample for each topic type.

After the topic type of the first text content is determined, an existing sample set for the topic type may be found from the constructed reference sample library, to obtain the corresponding image description reference sample.

Alternatively, the topic type may be input into the trained sample generation model, and the sample generation model analyzes and processes the topic type, to output the corresponding image description reference sample.

It should be noted that both S502 and S503 in this embodiment of the present disclosure are steps of obtaining the image description reference sample. Therefore, the present disclosure may perform at least one of S502 and S503.

In addition, because different users have different requirements for text-to-image generation, when the image description reference sample in the image prompt is automatically generated, the description keyword of the reference image to be generated corresponding to the reference text content in the image description reference sample may not meet the requirements of the users. Therefore, after the image description reference sample in the image prompt is obtained, the image description reference sample may be displayed to the user, to support the user in rewriting, as required, the description keyword of the reference image to be generated corresponding to the reference text content in the image description reference sample.

Then, for the image description reference sample in the image prompt, the present disclosure may further obtain rewrite information of the user for the description keyword of the reference image to be generated in the image description reference sample; and determine the corresponding image description reference sample based on the reference text content and the rewritten description keyword in the image description reference sample.

In other words, the present disclosure may obtain the rewrite information of the user for the description keyword of the reference image to be generated in the image description reference sample in real time, and combine the reference text content and the rewritten description keyword in the image description reference sample, to obtain the final image description reference sample.

Those skilled in the art may understand that in the foregoing method of the specific implementation, the drafted sequence of the steps does not mean a strict execution sequence, and does not constitute any limitation on the implementation process. The specific execution sequence of the steps should be determined based on functions and internal logic thereof.

Based on the same inventive concept, the embodiments of the present disclosure further provide a content generation apparatus corresponding to the content generation method. Because a principle of the apparatus in the embodiments of the present disclosure for solving the problem is similar to that of the content generation method in the foregoing embodiments of the present disclosure, implementation of the apparatus may refer to implementation of the method, and details are not repeated again herein.

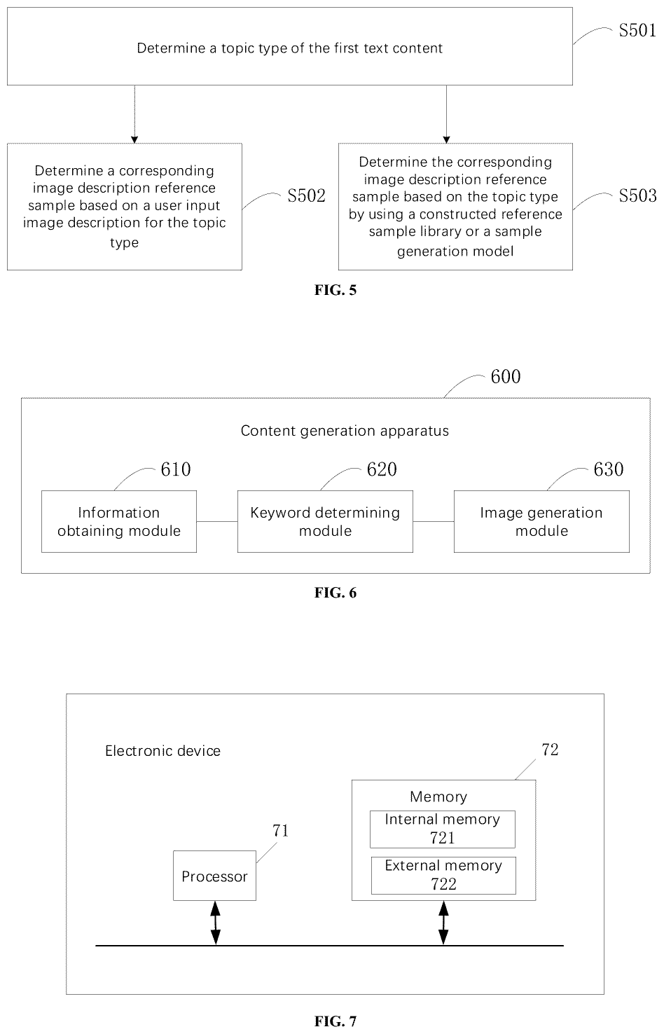

FIG. 6 is a schematic diagram of a content generation apparatus according to an embodiment of the present disclosure. The apparatus 600 includes:
an information obtaining module 610, configured to obtain first text content and an image prompt, wherein the first text content is used to describe content information of an image to be generated, and the image prompt is used to describe a generation requirement of the image to be generated;
a keyword determining module 620, configured to perform semantic analysis on the first text content and the image prompt based on a generative model to obtain a description keyword of the image to be generated corresponding to the first text content; and
an image generation module 630, configured to generate a target image corresponding to the first text content based on the description keyword of the image to be generated.

In an optional implementation, the information obtaining module 610 may include a text obtaining unit. The text obtaining unit may be configured to:
obtain second text content; and
segment the second text content by using a content segmentation model based on a shot prompt to obtain a plurality of first text content, where each first text content corresponds to a second text content segment, and the shot prompt is used to indicate a requirement for segmenting the second text content in a shot segment manner.

In an optional implementation, the content generation apparatus 600 may further include a video generation module. The video generation module may be configured to:
separately generate a plurality of target images based on the description keyword corresponding to each first text content; and
determine an order of the plurality of target images based on the second text content and a preset rule, and generate a target video based on the order, where the target video includes at least part of the target images.

In an optional implementation, the information obtaining module 610 may include an image prompt obtaining unit. The image prompt obtaining unit may be configured to:
obtain historical consumption data and/or hotspot data of a plurality of historical videos with a topic type the same as that of the first text content or the second text content;
determine, based on the historical consumption data and/or the hotspot data, a target image description and/or a target video frame that meet a popularity condition for the topic type, where the target image description includes at least one of the following: an image style, a target shot angle of view, a target subject description, a target person description, a target emotion description, a target action description, and a target background description; and
determine the image prompt based on the target image description and/or the target video frame.

In an optional implementation, the image prompt at least includes an image description reference sample, and the image description reference sample includes reference text content and a description keyword of a reference image to be generated corresponding to the reference text content.

In an optional implementation, the image prompt obtaining unit may be further configured to:
determine a topic type of the first text content;
determine a corresponding image description reference sample based on a user input image description for the topic type; and/or
determine the corresponding image description reference sample based on the topic type by using a constructed reference sample library or a sample generation model.

In an optional implementation, the content generation apparatus 600 may further include a sample rewriting module. The sample rewriting module may be configured to:
obtain rewrite information of a user for the description keyword of the reference image to be generated in the image description reference sample; and
determine the corresponding image description reference sample based on the reference text content and the rewritten description keyword in the image description reference sample.

In an optional implementation, the image prompt further includes: an image description dimension and a generation requirement for each image description dimension.

In an optional implementation, the keyword determining module 620 may be specifically configured to:
determine context information of each first text content based on a segmentation order of each first text content in the second text content; and
perform semantic analysis on the first text content, the context information of the first text content, and the image prompt based on a generative model for each first text content to obtain the description keyword of the image to be generated corresponding to the first text content.

In an optional implementation, the video generation module may be specifically configured to:
merge the target images corresponding to the plurality of first text content based on the segmentation order of each first text content in the second text content as the order of the target images to generate a target video.

In an optional implementation, the video generation module may be specifically configured to:
determine a segmentation order of each first text content based on a text number of each first text content in the second text content;
group the first text content and the target image corresponding to the first text content for each first text content to obtain a grouped target image corresponding to the first text content; and
merge the grouped target images corresponding to the plurality of first text content based on the segmentation order of the plurality of first text content as the order of the grouped target images to generate a target video.

In an optional implementation, the content generation apparatus 600 may further include a video publishing module. The video publishing module may be configured to:
add a target link to the target video, and publish the target video on a target platform, to obtain consumption data of a user for the target link during playback of the target video, so as to update the image prompt for a topic type of the target video.

Descriptions of a processing process of each module in the apparatus and an interaction process between the modules may refer to related descriptions in the foregoing method embodiment. Details are not described herein again.

An embodiment of the present disclosure further provides an electronic device. FIG. 7 is a schematic diagram of a structure of an electronic device according to an embodiment of the present disclosure. The electronic device includes:
a processor 71 and a memory 72, where the memory 72 stores machine-readable instructions executable by the processor 71, and the processor 71 is configured to execute the machine-readable instructions stored in the memory 72. When the machine-readable instructions are executed by the processor 71, the processor 71 is configured to perform the following steps.
Obtain first text content and an image prompt, wherein the first text content is used to describe content information of an image to be generated, and the image prompt is used to describe a generation requirement of the image to be generated;
perform semantic analysis on the first text content and the image prompt based on a generative model to obtain a description keyword of the image to be generated corresponding to the first text content; and
generate a target image corresponding to the first text content based on the description keyword of the image to be generated.

In an optional implementation, when the first text content is obtained, the processor 71 is configured to:
obtain second text content; and
segment the second text content by using a content segmentation model based on a shot prompt to obtain a plurality of first text content, where each first text content corresponds to a second text content segment, and the shot prompt is used to indicate a requirement for segmenting the second text content in a shot segment manner.

In an optional implementation, the processor 71 is further configured to:
separately generate a plurality of target images based on the description keyword corresponding to each first text content; and
determine an order of the plurality of target images based on the second text content and a preset rule, and generate a target video based on the order, where the target video includes at least part of the target images.

In an optional implementation, when the image prompt is obtained, the processor 71 is configured to:
obtain historical consumption data and/or hotspot data of a plurality of historical videos with a topic type the same as that of the first text content or the second text content;
determine, based on the historical consumption data and/or the hotspot data, a target image description and/or a target video frame that meet a popularity condition for the topic type, where the target image description includes at least one of the following: an image style, a target shot angle of view, a target subject description, a target person description, a target emotion description, a target action description, and a target background description; and
determine the image prompt based on the target image description and/or the target video frame.

In an optional implementation, the image prompt at least includes an image description reference sample, and the image description reference sample includes reference text content and a description keyword of a reference image to be generated corresponding to the reference text content. When the image prompt is obtained, the processor 71 is further configured to:
determine a topic type of the first text content;
determine a corresponding image description reference sample based on a user input image description for the topic type; and/or
determine the corresponding image description reference sample based on the topic type by using a constructed reference sample library or a sample generation model.

In an optional implementation, the processor 71 is further configured to:
obtain rewrite information of a user for the description keyword of the reference image to be generated in the image description reference sample; and
determine the corresponding image description reference sample based on the reference text content and the rewritten description keyword in the image description reference sample.

In an optional implementation, the image prompt further includes: an image description dimension and a generation requirement for each image description dimension.

In an optional implementation, when the description keyword of the image to be generated corresponding to the first text content is obtained by performing semantic analysis on the first text content and the image prompt based on a generative model, the processor 71 is configured to:
determine context information of each first text content based on a segmentation order of each first text content in the second text content; and
perform semantic analysis on the first text content, the context information of the first text content, and the image prompt based on a generative model for each first text content to obtain the description keyword of the image to be generated corresponding to the first text content.

In an optional implementation, when the order of the plurality of target images is determined based on the second text content and the preset rule, and the target video is generated based on the order, the processor 71 is configured to:

merge the target images corresponding to the plurality of first text content based on the segmentation order of each first text content in the second text content as the order of the target images to generate a target video.

In an optional implementation, when the target images corresponding to the plurality of first text content are merged based on the segmentation order of each first text content in the second text content as the order of the target images to generate a target video, the processor 71 is configured to:
determine a segmentation order of each first text content based on a text number of each first text content in the second text content;
group the first text content and the target image corresponding to the first text content, for each first text content, to obtain a grouped target image corresponding to the first text content; and
merge the grouped target images corresponding to the plurality of first text content based on the segmentation order of the plurality of first text content as the order of the grouped target images to generate a target video.

In an optional implementation, after the order of the plurality of target images is determined based on the second text content and the preset rule, and the target video is generated based on the order, the processor 71 is further configured to:
add a target link to the target video, and publish the target video on a target platform, to obtain consumption data of a user for the target link during playback of the target video, so as to update the image prompt for a topic type of the target video.

The foregoing memory 72 includes an internal memory 721 and an external memory 722. The internal memory 721, also referred to as an internal storage, is configured to temporarily store operation data in the processor 71 and data exchanged with the external memory 722 such as a hard disk. The processor 71 exchanges data with the external memory 722 through the internal memory 721.

A specific execution process of the foregoing instructions may refer to steps of the content generation method described in the embodiment of the present disclosure, and details are not described herein again.

An embodiment of the present disclosure further provides a computer-readable storage medium storing a computer program. When the computer program is run by a processor, the steps of the content generation method described in the foregoing method embodiment are performed. The storage medium may be a volatile or non-volatile computer-readable storage medium.

An embodiment of the present disclosure further provides a computer program product carrying program code. Instructions included in the program code may be used to perform the steps of the content generation method described in the foregoing method embodiment. For details, refer to the foregoing method embodiment, which is not described herein again.

The computer program product may be specifically implemented by hardware, software, or a combination thereof. In an optional embodiment, the computer program product is specifically embodied as a computer storage medium. In another optional embodiment, the computer program product is specifically embodied as a software product, for example, a software development kit (SDK) or the like.

A person skilled in the art may clearly understand that for the convenience and brevity of description, for a specific working process of the system and the apparatus described above, reference may be made to corresponding processes in the foregoing method embodiments, and details are not described herein again. In the several embodiments provided in the present disclosure, it should be understood that the disclosed system, apparatus, and method may be implemented in other manners. The foregoing apparatus embodiments are merely illustrative. For example, the division of the units is merely a logical function division, and there may be another division manner in actual implementation. For example, a plurality of units or components may be combined or integrated into another system, or some features may be ignored or not performed. In addition, the displayed or discussed mutual couplings or direct couplings or communication connections may be implemented through some communication interfaces. The indirect couplings or communication connections between the apparatuses or units may be implemented in electrical, mechanical, or other forms.

The units described as separate parts may or may not be physically separate, and parts displayed as units may or may not be physical units, and may be located in one position, or may be distributed on a plurality of network units. Some or all of the units may be selected according to actual needs to achieve the objectives of the solutions of the embodiments.

In addition, the functional units in each embodiment of the present disclosure may be integrated into one processing unit, or each of the units may exist alone physically, or two or more units may be integrated into one unit.

If the functions are implemented in the form of a software functional unit and sold or used as an independent product, the functions may be stored in a non-volatile computer-readable storage medium executable by a processor. Based on such an understanding, the technical solutions of the present disclosure are essentially or the part contributing to the related art or part of the technical solutions may be embodied in the form of a software product. The computer software product is stored in a storage medium, and includes several instructions for instructing an electronic device (which may be a personal computer, a server, a network device, or the like) to perform all or some of the steps of the methods described in the embodiments of the present disclosure. The foregoing storage medium includes: any medium that can store program code, such as a USB flash drive, a mobile hard disk, a read-only memory (ROM), a random access memory (RAM), a magnetic disk, or an optical disc.

Finally, it should be noted that the foregoing embodiments are merely specific implementations of the present disclosure, and are used for illustrating the technical solutions of the present disclosure, but not for limiting the present disclosure. The scope of protection of the present disclosure is not limited thereto. Although the present disclosure is described in detail with reference to the foregoing embodiments, persons of ordinary skill in the art should understand that they may still, within the technical scope disclosed by the present disclosure, modify or easily think about variations to the technical solutions described in the foregoing embodiments or may easily make equivalent replacements to some technical features thereof, while these modifications, variations and replacements do not make the corresponding technical solutions depart from the spirit and scope of the technical solutions of the embodiments of the present disclosure, and all should fall within the scope of protection of the present disclosure. Therefore, the scope of protection of the present disclosure shall be subject to the scope of protection of the claims.

1. A content generation method, comprising:
obtaining first text content and an image prompt, wherein the first text content is configured to describe content information of an image to be generated, and the image prompt is configured to describe a generation requirement of the image to be generated;
performing semantic analysis on the first text content and the image prompt based on a generative model to obtain a description keyword of the image to be generated corresponding to the first text content; and
generating a target image corresponding to the first text content based on the description keyword of the image to be generated.

2. The method according to claim 1, wherein the obtaining first text content comprises:
obtaining second text content; and
segmenting the second text content by using a content segmentation model based on a shot prompt to obtain a plurality of first text content, each first text content corresponding to a second text content segment, wherein the shot prompt is configured to indicate a requirement for segmenting the second text content in a shot segment manner.

3. The method according to claim 2, further comprising:
separately generating a plurality of target images based on the description keyword corresponding to each first text content; and
determining an order of the plurality of target images based on the second text content and a preset rule, and generating a target video based on the order, wherein the target video comprises at least part of the target images.

4. The method according to claim 1, wherein the obtaining an image prompt comprises:
obtaining at least one of historical consumption data or hot spot data of a plurality of historical videos that are of a same topic type as the first text content or the second text content;
determining, based on at least one of the historical consumption data or the hot spot data, at least one of a target image description or a target video frame that meets a popularity condition for the topic type, wherein the target image description comprises at least one of the following: an image style, a target shot angle of view, a target subject description, a target person description, a target emotion description, a target action description, and a target background description; and
determining the image prompt based on at least one of the target image description or the target video frame.

5. The method according to claim 1, wherein the image prompt at least comprises an image description reference sample, wherein the image description reference sample comprises reference text content and a description keyword of a reference image to be generated corresponding to the reference text content.

6. The method according to claim 5, wherein the obtaining an image prompt further comprises:
determining a topic type of the first text content; and
at least one of:
determining a corresponding image description reference sample based on a user input image description for the topic type; or
determining a corresponding image description reference sample based on the topic type by using a constructed reference sample library or a sample generation model.

7. The method according to claim 5, further comprising:
obtaining rewriting information of a user for the description keyword of the reference image to be generated in the image description reference sample; and
determining a corresponding image description reference sample based on the reference text content and the rewritten description keyword in the image description reference sample.

8. The method according to claim 5, wherein the image prompt further comprises: an image description dimension and a generation requirement for each image description dimension.

9. The method according to claim 2, wherein the performing semantic analysis on the first text content and the image prompt based on a generative model to obtain a description keyword of the image to be generated corresponding to the first text content comprises:
determining context information of each first text content based on a segmentation order of each first text content in the second text content; and
performing semantic analysis on the first text content, the context information of the first text content, and the image prompt based on a generative model for each first text content to obtain the description keyword of the image to be generated corresponding to the first text content.

10. The method according to claim 3, wherein the determining an order of the plurality of target images based on the second text content and a preset rule, and generating a target video based on the order comprises:
merging the target images corresponding to the plurality of first text content based on the segmentation order of each first text content in the second text content as the order of the target images to generate a target video.

11. The method according to claim 10, wherein the merging the target images corresponding to the plurality of first text content based on the segmentation order of each first text content in the second text content as the order of the target images to generate a target video comprises:
determining the segmentation order of each first text content based on a text number of each first text content in the second text content;
grouping the first text content and the target image corresponding to the first text content for each first text content to obtain a grouped target image corresponding to the first text content; and
merging the grouped target images corresponding to the plurality of first text content based on the segmentation order of the plurality of first text content as the order of the grouped target images to generate a target video.

12. The method according to claim 3, wherein after the determining an order of the plurality of target images based on the second text content and a preset rule, and generating a target video based on the order, the method further comprises:
adding a target link to the target video, and publishing the target video on a target platform, to obtain consumption data of a user for the target link during playback of the target video, so as to update the image prompt for the topic type of the target video.

13. An electronic device, comprising: a processor and a memory, wherein the memory stores machine-readable instructions executable by the processor, the processor is configured to execute the machine-readable instructions stored in the memory, and when the machine-readable instructions are executed by the processor, the processor executes a content generation method, comprising:
obtaining first text content and an image prompt, wherein the first text content is configured to describe content information of an image to be generated, and the image prompt is configured to describe a generation requirement of the image to be generated;
performing semantic analysis on the first text content and the image prompt based on a generative model to obtain a description keyword of the image to be generated corresponding to the first text content; and
generating a target image corresponding to the first text content based on the description keyword of the image to be generated.

14. The electronic device according to claim 13, wherein the obtaining first text content comprises:
obtaining second text content; and
segmenting the second text content by using a content segmentation model based on a shot prompt to obtain a plurality of first text content, each first text content corresponding to a second text content segment, wherein the shot prompt is configured to indicate a requirement for segmenting the second text content in a shot segment manner.

15. The electronic device according to claim 14, wherein the processor further executes the step of:
separately generating a plurality of target images based on the description keyword corresponding to each first text content; and
determining an order of the plurality of target images based on the second text content and a preset rule, and generating a target video based on the order, wherein the target video comprises at least part of the target images.

16. The electronic device according to claim 13, wherein the obtaining an image prompt comprises:
obtaining at least one of historical consumption data or hot spot data of a plurality of historical videos that are of a same topic type as the first text content or the second text content;
determining, based on at least one of the historical consumption data or the hot spot data, at least one of a target image description or a target video frame that meets a popularity condition for the topic type, wherein the target image description comprises at least one of the following: an image style, a target shot angle of view, a target subject description, a target person description, a target emotion description, a target action description, and a target background description; and
determining the image prompt based on at least one of the target image description or the target video frame.

17. A non-transitory computer-readable storage medium storing a computer program, wherein the computer program, when executed by a processor, causes the processor to perform a content generation method, comprising:
obtaining first text content and an image prompt, wherein the first text content is configured to describe content information of an image to be generated, and the image prompt is configured to describe a generation requirement of the image to be generated;
performing semantic analysis on the first text content and the image prompt based on a generative model to obtain a description keyword of the image to be generated corresponding to the first text content; and
generating a target image corresponding to the first text content based on the description keyword of the image to be generated.

18. The non-transitory computer-readable storage medium according to claim 17, wherein the obtaining first text content comprises:
obtaining second text content; and
segmenting the second text content by using a content segmentation model based on a shot prompt to obtain a plurality of first text content, each first text content corresponding to a second text content segment, wherein the shot prompt is configured to indicate a requirement for segmenting the second text content in a shot segment manner.

19. The non-transitory computer-readable storage medium according to claim 18, wherein the computer program, when executed by a processor, further causes the processor to perform the step of:
separately generating a plurality of target images based on the description keyword corresponding to each first text content; and
determining an order of the plurality of target images based on the second text content and a preset rule, and generating a target video based on the order, wherein the target video comprises at least part of the target images.

20. The non-transitory computer-readable storage medium according to claim 17, wherein the obtaining an image prompt comprises:
obtaining at least one of historical consumption data or hot spot data of a plurality of historical videos that are of a same topic type as the first text content or the second text content;
determining, based on at least one of the historical consumption data or the hot spot data, at least one of a target image description or a target video frame that meets a popularity condition for the topic type, wherein the target image description comprises at least one of the following: an image style, a target shot angle of view, a target subject description, a target person description, a target emotion description, a target action description, and a target background description; and
determining the image prompt based on at least one of the target image description or the target video frame.
